(19) United States
(12) Patent Application Publication
(10) Pub. No.: US 2009/0235691 A1
(43) Pub. Date: Sep. 24, 2009

(54) System and Method for Configuring a Glass Hardening System Capable of Transition between Configurations for Annealing and Tempering Glass Objects

(75) Inventors: Dennis Postupack, Alpharetta, GA (US); Sterling L. Steward, Douglasville, GA (US)

Correspondence Address: THE COCA-COLA COMPANY;PATENT & TECHNOLOGY DEPT--NAT 19, P. O. BOX 1734, ATLANTA, GA, 30301, US

(73) Assignee: THE COCA-COLA COMPANY, Atlanta, GA (US)

(21) Appl. No.: 12/473,363

(22) Filed: May 28, 2009

Related U.S. Application Data
(63) Continuation-in-part of application No. 10/813,435, filed on Mar. 31, 2004.

(51) Int. Cl. C03B 18/18; C03B 27/00; C03B 25/00

(52) U.S. Cl. 65/29.19; 65/162

(57) ABSTRACT

The present invention relates to a glass hardening system and method capable of transition between configurations for annealing and tempering glass objects comprising a conveyor system, a glass object positioning system, a tempering chamber, and a plurality of temperature zones oriented to form a tunnel through which glass objects are conveyed by a conveyor system. The temperature zones can be set to implement a temperature profile for either annealing or tempering the glass objects. Furthermore, in an exemplary embodiment an annealing lehr can be configured to temper glass objects by making a portion of the conveyor system accessible to the glass object positioning system after preheating, such that the glass object positioning system can temporarily relocate the glass objects from the conveyor into a tempering chamber and then the glass objects are returned to the conveyor system.

### CROSS-REFERENCE TO RELATED APPLICATIONS

This application contains subject matter which is related to the subject matter of the following co-pending applications, each of which is assigned to the same assignee as this application, The Coca-Cola Company, Atlanta, Ga., U.S.A. Each of the below listed applications is hereby incorporated herein by reference in its entirety:

The present application is a continuation in part application of an application entitled ‘METHOD AND APPARATUS FOR STRENGTHENING GLASS’, inventor Postupack et al., filed Mar. 31, 2004 and assigned Ser. No. 10/813,435.

### TRADEMARKS

COCA-COLA® is a registered trademark of The Coca-Cola Company, Atlanta, Ga., U.S.A. Other names used herein may be registered trademarks, trademarks or product names of The Coca-Cola Company or other companies.

### TECHNICAL FIELD OF THE INVENTION

This invention relates to a glass hardening system and method capable of transition between configurations for annealing and tempering glass objects and in particular to a glass hardening system comprising a conveyor system, a glass object positioning system, a tempering chamber, and a plurality of temperature zones oriented to form a tunnel through which glass objects are conveyed by a conveyor system. The temperature zones can be set to implement a temperature profile for either annealing or tempering the glass objects. Furthermore, in an exemplary embodiment an annealing lehr can be configured to temper glass objects by making a portion of the conveyor system accessible to the glass object positioning system after preheating, such that the glass object positioning system can temporarily relocate the glass objects from the conveyor into a tempering chamber and then return the glass objects to the conveyor system.

### BACKGROUND OF THE INVENTION

Before our invention FIG. 1A illustrates a prior art glass hardening manufacture which includes vessel a forming station 102, an annealing station 104, and a packaging and palletizing station 106. In this prior art embodiment vessels are formed in the vessel forming station 102 and conveyed to an annealing lehr station 104. Prior art annealing lehr station 104 has a dedicated function of annealing the newly formed vessels. Exiting the annealing lehr station 104 the vessels are then packaged and palletized at station 106 for storage and shipment. In a prior art embodiment, should tempering of the vessels be preferred over annealing a separate dedicated tempering station needs to be installed. FIG. 1B illustrates such a dedicated tempering station 108.

Referring to FIG. 1B there is a prior art glass hardening manufacture including a vessel forming station 102, an annealing station 104, a tempering station 108, and packaging and palletizing station 106. This prior art embodiment illustrates how a separate dedicated tempering system 108 needs to be installed and the vessels routed between an annealing station 104 and a tempering station 108 should selectivity between annealing and tempering vessel hardening systems be desired.

Shortcomings of using a dedicate tempering station 108 is that production line speed can be slower for the tempering process requiring the vessels to be stored and or staged between the vessel forming station 102 and tempering station 108. This requires additional conveying equipment and can lead to vessel quality problems.

There is a long felt need to be able to be able to transition between annealing and tempering vessels without having to purchase, install, and pay the cost to operate a separate dedicate tempering station. In addition, there is a desire to avoid negatively impacting production line speed, and thus avoid having to add additional conveying line to accommodate the need to store and or stage the formed vessels prior to tempering. Furthermore, there is a need to overcome the shortcoming of the prior art to improve vessel quality and use less energy by not having to operate a separate dedicate tempering station. There is also a need to be able to leverage a large install base of annealing lehr equipment to anneal and temper glass vessel, rather than having to purchase, install, and operate additional dedicated tempering stations equipment. These and other shortcoming gives rise to the present invention.

### SUMMARY OF THE INVENTION

The shortcomings of the prior art are overcome and additional advantages are provided through the provision of a glass hardening system capable of transition between configurations for annealing and tempering glass objects. The glass hardening system comprising: a conveyor system, a glass object positioning system, a tempering chamber, and a plurality of temperature zones oriented to form a tunnel with openings on either end of the tunnel through which a plurality of glass objects are conveyed by the conveyor system. Each of the plurality of temperature zones being either a heating zone or a cooling zone and each of the plurality of temperature zones having an adjustable temperature such that the plurality of temperature zones can be set to implement a temperature profile necessary for either annealing or tempering the plurality of glass objects. Wherein the glass hardening system is configured to anneal the plurality of glass objects when the tunnel remains sealed except for openings on either end to allow ingress and egress of the plurality of glass objects and the temperature profile implemented is an annealing temperature profile. The glass hardening system is transitioned to temper the plurality of glass objects when the glass hardening system is configured such that a portion of the conveyor system is accessible to the glass object positioning system after preheating of the plurality of glass objects, such that the glass object positioning system can temporarily relocate a portion of the plurality of glass objects from the conveyor system into the tempering chamber, wherein the portion of the plurality of glass objects are tempered and then the portion of the plurality of glass objects is returned to the conveyor system to complete the temperature profile.

Additional shortcomings of the prior art are overcome and additional advantages are provided through the provision of a method of configuring a glass hardening system capable of transition between configurations for annealing and tempering glass objects. The method comprising: orientating a plurality of temperature zones to form a tunnel with openings on either end of the tunnel through which a plurality of glass objects are conveyed by a conveyor system. Each of the plurality of temperature zones being either a heating zone or a cooling zone and each of the plurality of temperature zones having an adjustable temperature, such that the plurality of temperature zones can be set to implement a temperature profile necessary for either annealing or tempering the plurality of glass objects. Setting the temperature profile for either annealing or tempering the plurality of glass objects. Configuring selectively the glass hardening system to anneal the plurality of glass objects by causing the tunnel to remain sealed except for opening on either end to allow ingress and egress of the plurality of glass objects. Configuring selectively the glass hardening system to temper the plurality of glass objects by making a portion of the conveyor system accessible to a glass object positioning system after preheating of the plurality of glass objects, such that the glass object positioning system can temporarily relocate a portion of the plurality of glass objects from the conveyor system into a tempering chamber. Wherein the portion of the plurality of glass objects is tempered and then the portion of the plurality of glass objects is returned to the conveyor. Conveying the plurality of glass objects through the plurality of temperature zones exposing each of the plurality of glass object to the temperature profile, wherein the plurality of glass objects are either annealed or tempered.

Additional shortcomings of the prior art are overcome and additional advantages are provided through the provision of a method of configuring an annealing lehr to temper glass objects. The method comprising: orientating a plurality of temperature zones to form a tunnel with openings on either end of the tunnel through which a plurality of glass objects are conveyed by a conveyor system. Each of the plurality of temperature zones being either a heating zone or a cooling zone and each of the plurality of temperature zones having an adjustable temperature, such that the plurality of temperature zones can be set to implement a temperature profile necessary for either annealing or tempering the plurality of glass objects. Configuring the annealing lehr to temper the plurality of glass objects by making a portion of the conveyor system accessible to a glass object positioning system after preheating of the plurality of glass objects. Setting the temperature profile for tempering the plurality of glass objects. Conveying the plurality of glass object through the plurality of temperature zones exposing each of the plurality of glass object to the temperature profile. Relocating by way of the glass object positioning system a portion of the plurality of glass objects from the conveyor system into a tempering chamber. Tempering the portion of the plurality of glass objects and returning the portion of the plurality of glass objects to the conveyor system.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE FIGURES

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1A illustrates one example of a prior art glass hardening manufacture including a vessel forming station, an annealing station, and a packaging and palletizing station 106;

FIG. 1B illustrates one example of a prior art glass hardening manufacture including a vessel forming station, an annealing station, a tempering station, and a packaging and palletizing station;

FIG. 2A-2B illustrates two examples of glass objects;

FIG. 3A illustrates one example of a glass hardening system configured as an annealing lehr with a plurality of temperature zones shown with a corresponding temperature graph and temperature profile for annealing a plurality of glass objects;

FIG. 3B illustrates one example of a glass hardening system configured for tempering with a plurality of temperature zones, robot system, and tempering chamber shown with a corresponding temperature graph and temperature profile for tempering a plurality of glass objects;

FIG. 3C illustrates one example of a glass hardening system configured for simultaneously tempering a plurality of rows of a portion of the plurality of glass objects;

FIG. 3D illustrates one example of a glass hardening system configured for simultaneously tempering a plurality of rows of a portion of the plurality of glass objects with the tempering chamber located on top of at least one of the temperature zones;

FIG. 4 illustrates one example of a method of configuring a glass hardening system capable of transition between configurations for annealing and tempering glass objects; and

FIG. 5 illustrates one example of a method for configuring an annealing lehr to temper glass objects.

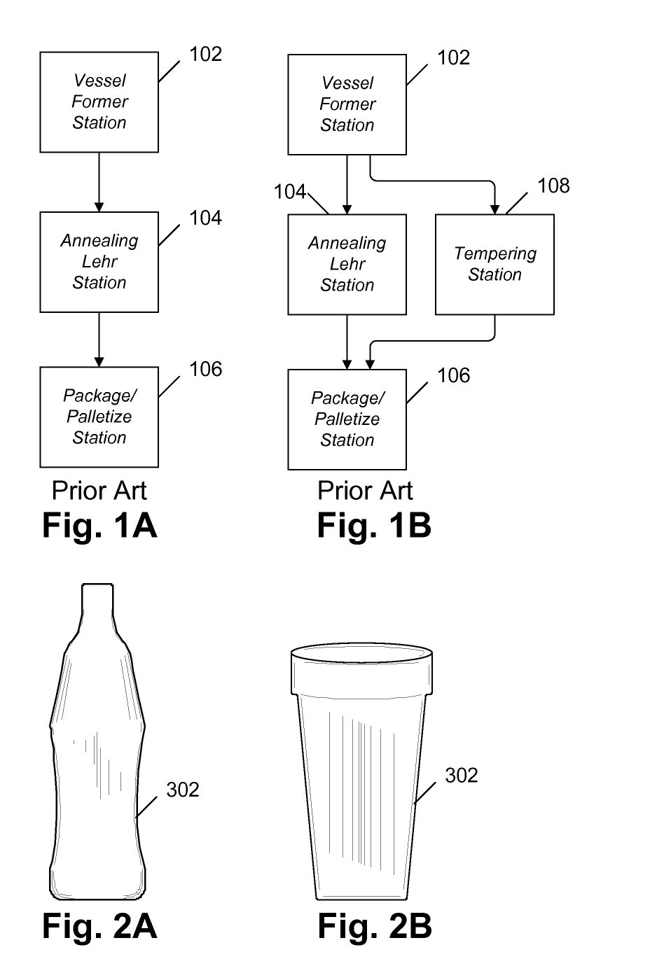

The detailed description explains the preferred embodiments of the invention, together with advantages and features, by way of example with reference to the drawings.

### DETAILED DESCRIPTION OF THE INVENTION

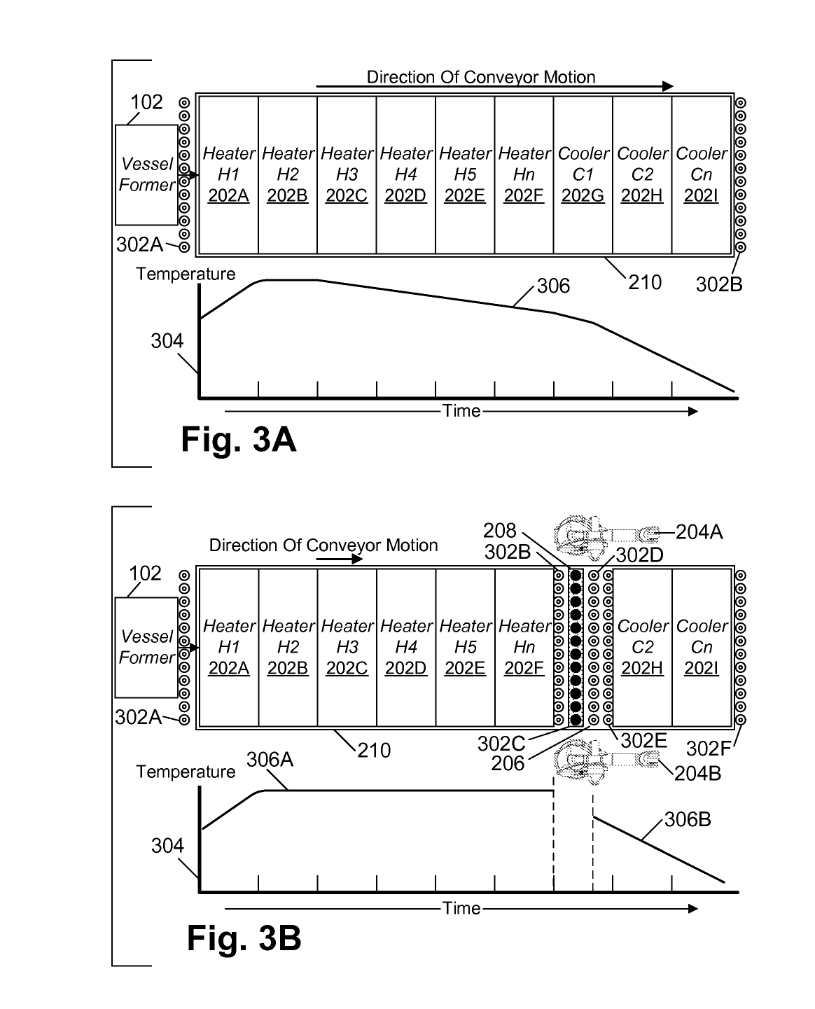

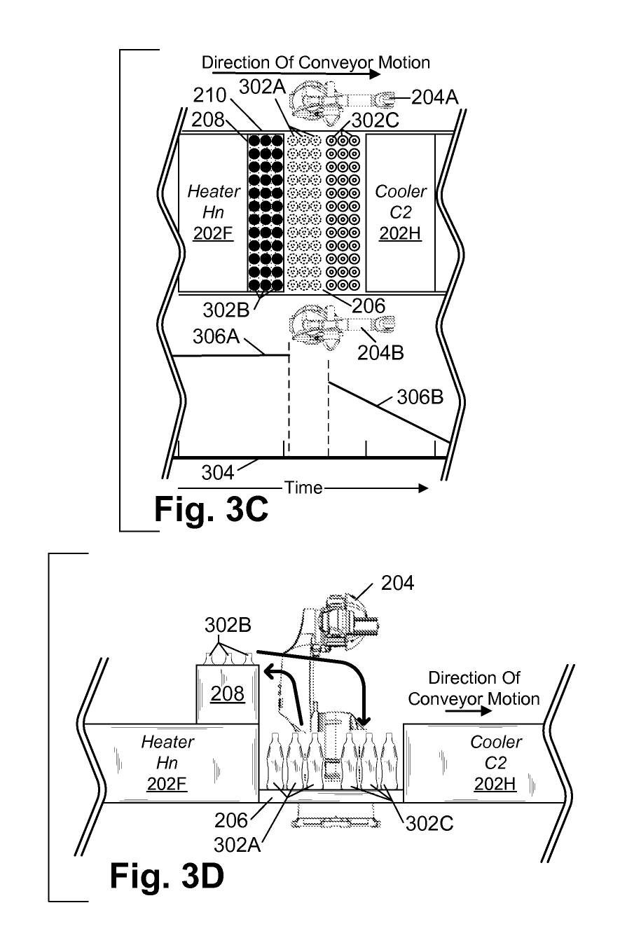

Turning now to the drawings in greater detail, the invention of the present invention overcomes the need to have separate annealing and tempering systems instead effectuating the ability to selectively choose between annealing and tempering through the use of a single annealing lehr. Such an anneal lehr can be a E. W. BOWMAN, AMERICAN PENNEKAMP, or other type and or kind of annealing lehr, as may be required and or desired in a particular embodiment. For purposes of disclosure referring to FIGS. 2A-2B there is illustrated two examples of glass objects. FIG. 2A illustrates a bottle 302 and FIG. 2B illustrates a vessel 302. Bottle 302 and vessel 302 can be referred to as vessel 302 or glass object 302. In addition, the processing of a plurality of vessels 302 can also be referred to as a plurality of glass objects 302 or 302A-302F as shown in FIGS. 3A-3D. For purposes of disclosure tempering can also be referred to as heat strengthening.

Referring to FIG. 3A there is illustrated one example of a glass hardening system configured as an annealing lehr 202 with a plurality of temperature zones 202A-202I shown with a corresponding temperature graph 304 and temperature profile 306 for annealing a plurality of glass objects 302A-302B. In an exemplary embodiment, an annealing lehr can comprise a plurality of temperature zones 202A-202I. The plurality of temperature zones can be oriented to form a tunnel with openings on either end of the tunnel through which a plurality of glass objects 302A-302B can be conveyed by a conveyor system 206. Each of the plurality of temperature zones 202A-202I are either a heating zone or a cooling zone and each of the plurality of temperature zones 202A-202I have an adjustable temperature, such that the plurality of temperature zones 202A-202I can be set to implement a temperature profile 304 necessary for, in this embodiment, annealing the plurality of glass objects 302 also referred to as 302A-302B.

In an exemplary embodiment, the glass hardening system is configured to anneal the plurality of glass objects 302 when the tunnel remains sealed except for openings on either end to allow ingress and egress of the plurality of glass objects shown as 302A-302B and the temperature profile 306 implemented is an annealing temperature profile.

Also illustrated in FIG. 3A is temperature graph 304 showing an annealing temperature profile 306 that corresponds to the temperature setting of each of the plurality temperature zones 202A-202I. As example and not a limitation, according to the temperature profile 306, temperature zone heater H1 202A increases the temperature of the plurality of glass object at position 302A entering the annealing lehr 210. Temperature zone heater H2 202B holds the plurality of glass object at a constant temperature. Temperature zones heater H3 202C through heater Hn 202F gradually decrease the temperature of the plurality of glass objects 302A. Temperature zones cooler C1-Cn then cools the plurality of glass objects. The conveyor system 206 transports the plurality of glass objects at position 302A from the vessel former 102 through the glass hardening system 210. The plurality of glass objects shown at position 302B exit the glass hardening system 210 and are conveyed to other manufacturing steps, as may be required and or desired in a particular embodiment.

In a plurality of embodiment the number of temperature zones can vary. In this regard, FIGS. 3A-3D illustrate a varying number of heating zones as heaters H1-Hn and a varying number of cooling zones as coolers C1-Cn.

For disclosure purposes a plurality of glass objects 302A is a collection of vessels 302 and can be organized in a row to effectuate the processing of moving many vessels 302 at a time. In production such rows of vessels 302 are in continuous motion to and through the glass hardening system 210. A select row or rows of vessels 302 can be referred to as a portion of a plurality of glass objects 302. The FIGS. 3A-3D illustrates a row, rows, and the relative location in the manufacturing process of a portion of a plurality of glass objects referenced as 302A-302F.

Referring to FIG. 3B there is illustrated one example of a glass hardening system configured for tempering with a plurality of temperature zones 202A-202I, glass object positioning system 204A-204B, and tempering chamber 208 shown with a corresponding temperature graph 304 showing a temperature profile 306A-306B for tempering a plurality of glass objects. In an exemplary embodiment of the present invention, a glass hardening system initially designed for annealing glass objects can be transitioned and configured to temper glass objects.

An advantage of the present invention is that a separate glass hardening system for tempering glass object does not need to be purchased. Another advantage is that the conveyor system and production line speed does not need to be altered and that an annealing lehr can be transitioned and configured between an annealing and a tempering method to hardening the glass objects 302.

In an exemplary embodiment, a glass hardening system initially configured for annealing glass objects can be transitioned to temper a plurality of glass objects. In this regard, the glass hardening system can be configured such that a portion of the conveyor system 206 is accessible to a glass object positioning system 204A-204B. Such glass object positioning can occur after the preheating stage of the plurality of glass objects at position 302B. The glass object positioning system 204A-204B can temporarily relocate a portion of the plurality of glass objects at position 302B from the conveyor system 206 into the tempering chamber 208, wherein the portion of the plurality of glass objects at position 302C are tempered. The portions of the plurality of glass objects, at position 302D, are returned to the conveyor system 206 to complete the temperature profile and method. The plurality of glass object exit at position 306F.

In this embodiment, tempering chamber 208 is located between temperature zones 202F and 202H. Alternatively, FIG. 3D illustrates the tempering chamber 208 being located on top of at least one of the temperature zones such as temperature zone 202F.

Also illustrated in FIG. 3B is temperature graph 304 showing a tempering temperature profile 306A-306B that corresponds to the temperature setting of each of a plurality temperature zones. As example and not a limitation, temperature zone heater H1 202A increases the temperature of the plurality of glass object 302A as they entering the glass hardening system 210 to a pre heat temperature following the temperature profile 306A. Temperature zone heater H2 202B through heater Hn 202F hold the plurality of glass object at a constant preheat temperature. In an exemplary embodiment, the input temperature of the plurality of glass objects 302A varies in the range of 550 degrees Celsius and the stable preheat temperature is in the range of 700 degrees Celsius.

The conveyor system 206 transports the plurality of glass objects at position 302A from the vessel former 102 through the glass hardening system 210. A portion of the plurality of glass objects at position 302B exiting the preheating phase and are then relocated by way of the glass object positioning system 204A-204B from the conveyor system 206 into a tempering chamber 208. The portion of the plurality of glass objects at position 302C is then tempered. Such tempering can be effectuated by way of blowing gas or liquid on the portion of the plurality of the glass objects at position 302C while the portion of the plurality of glass objects at position 302C are in the tempering chamber 208. In an exemplary embodiment, the gas can be air or other gas, as may be required and or desired in a particular embodiment. The portion of the plurality of glass objects at position 302D is then returned to the conveyor system 206 without interruption to the plurality of glass objects being transported along the conveyor system 206.

In an exemplary embodiment when the portion of the plurality of glass objects at position 302D are returned to the conveyor system 206 they continue through the temperature profile 306B entering the remaining temperature zones 202H-202I and exit the glass hardening system at position 302F. The plurality of glass objects can then be conveyed to other manufacturing processes as may be required and or desired in a particular embodiment.

In a plurality of embodiment the number of temperature zones can vary. In this regard, FIGS. 3A-3D illustrate a varying number of heating zones as heater H1-Hn and a varying number of cooling zones as cooler C1-Cn.

Referring to FIG. 3C there is illustrated a glass hardening system configured for simultaneously tempering of a plurality of rows of a portion of the plurality of glass objects 302. In an exemplary embodiment, the tempering chamber 208 and the robot system 204A-204B can be configured to temper simultaneously a plurality of rows of a portion of the plurality of glass objects shown at positions 302A-302C, wherein the number of the plurality of rows can be determined based on conveyor system 206 speed, as the conveyor 206 moves glass objects 302 through the glass hardening system 210, and amount of time required to required to transport, temper, and return the portion of the plurality of glass objects to and from positions 302A-302C to the conveyor system 206, without interruption to the plurality of glass objects being transported along the conveyor system.

Referring to FIG. 3D there is illustrated one example of a glass hardening system 210 configured for simultaneously tempering a plurality of rows of a portion of the plurality of glass objects shown at positions 302A-302C with the tempering chamber 208 located on top of at least one of the temperature zones 202F. In an exemplary embodiment the tempering chamber 208 can be located on top of one of the temperature zones. In this regard, the glass object positioning system 204 can remove glass object located position 302A from the conveyor 206 and place them in the tempering chamber 208 located on top of a temperature zone such as 202F illustrated in the FIG. 3D illustrated as position 302B. After tempering the glass object positioning system 204 can remove the glass objects at position 302B from the tempering chamber 208 and relocate the glass object to position 302C back on the conveyor 206 allowing the glass objects to complete the tempering temperature profile and method.

In this exemplary embodiment the tempering chamber 208 is located on top of at least one of the temperature zones, such as temperature zone 202F. Alternatively, FIG. 3B illustrates the tempering chamber 208 being located between the temperature zones 202F and 202H.

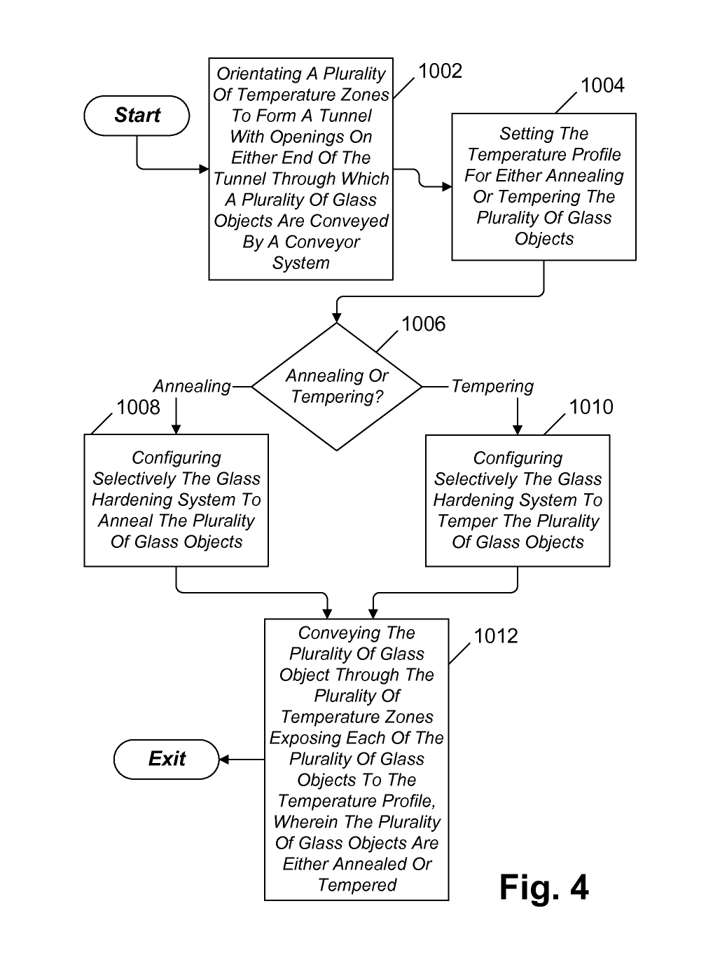

Referring to FIG. 4 there is illustrated one example of a method of configuring a glass hardening system 210 capable of transition between configurations for annealing and tempering glass objects 302. In an exemplary embodiment of the present invention a glass hardening system 210 can be configured to either anneal or temper a plurality of glass objects 302. The method begins in block 1002.

In block 1002 a plurality of temperature zones are orientated to form a tunnel with openings on either end through which a plurality of glass objects 302 are conveyed by a conveyor system 206, each of the plurality of temperature zones 202A-202I being either a heating zone or a cooling zone and each of the plurality of temperature zones 202A-202I and can have an adjustable temperature, such that the plurality of temperature zones can be set to implement a temperature profile 306 or 306A-306B as necessary for either annealing or tempering the plurality of glass objects 302. The method continues in block 1004.

In block 1004 a temper profile 306 for either annealing or tempering the plurality of glass objects 302 is set. The method continues in decision block 1006.

In decision block 1006 a determination is made as to whether annealing or tempering is desired. If the resultant is annealing then the method continues in block 1008. If the resultant is tempering then the method continues in block 1010.

In block 1008 the glass hardening system 210 is selectively configured to anneal the plurality of glass objects 302 by causing the tunnel formed by the heating zones to remain sealed except for openings on either end to allow ingress and egress of the plurality of glass objects 302. The method continues in block 1012.

In block 1010 the glass hardening system 210 is selectively configured to temper the plurality of glass objects 302 by making a portion of the conveyor system 206 accessible to a glass object positioning system 204 or 204A-204B after preheating of the plurality of glass objects 302, such that the glass object positioning system 204 or 204A-204B can temporarily relocate a portion of the plurality of glass objects 302 from the conveyor system 206 into a tempering chamber 208, wherein the portion of the plurality of glass objects 302 are tempered. The glass object positioning system 204 or 204A-204B then return the portion of the plurality of glass objects 302 to the conveyor 206.

In an exemplary embodiment, tempering can be effectuated by blowing gas or liquid on the portion of the plurality of the glass objects 302 while the portion of the plurality of glass objects 302 are in the tempering chamber 208. Such a gas can be air or other gas, as may be required and or desired in a particular embodiment.

Furthermore, in an exemplary embodiment, the temperature zones 202A-202F can be set to raise the temperature of the plurality of glass objects 302 from an initial starting temperature upon entry into the glass hardening system 210 of less than 700 degrees Celsius to a before tempering preheat temperature of approximately 700 degrees Celsius.

In addition, the tempering chamber 208 and the glass object positioning system 204 or 204A-204B can be configured to transport and simultaneously temper a plurality of rows of a portion of the plurality of glass objects 302, wherein the number of the plurality of rows can be determined based on conveyor system 206 speed and amount of time required to transport, temper, and return the portion of the plurality of glass objects 302 to the conveyor system 206, without interruption to the plurality of glass objects being transported along the conveyor system. The method continues in block 1012.

In block 1012 the plurality of glass objects 302 are conveyed through the plurality of temperature zones 202A-202I exposing each of the plurality of glass object 302 to the temperature profile 306 or 306A-306B, wherein the plurality of glass objects 302 are either annealed or tempered. The method is then exited.

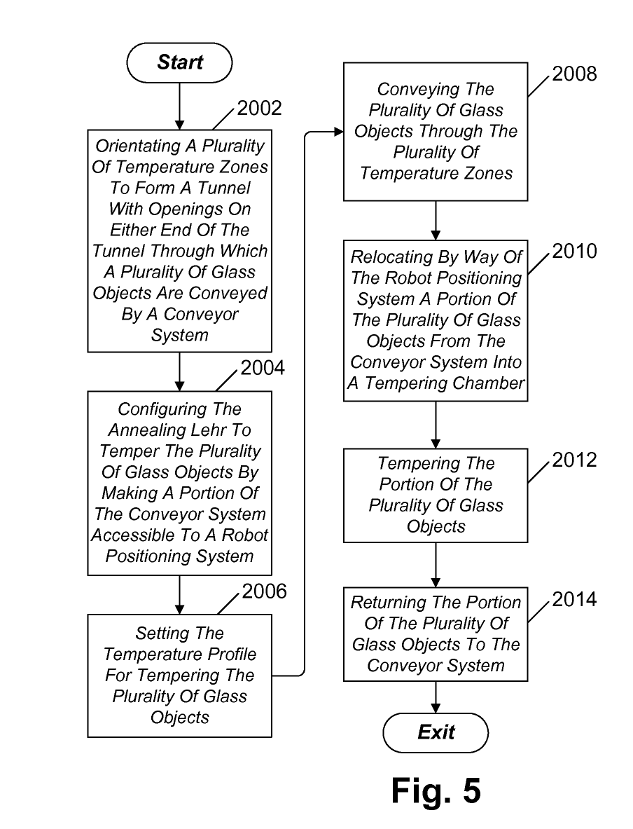

Referring to FIG. 5 there is illustrated one example of a method for configuring an annealing lehr to temper glass objects. In an exemplary embodiment, the present invention can transition an annealing lehr through configuration such that hardening glass by tempering can be effectuated. The method begins in block 2002.

In block 2002 a plurality of temperature zones 202A-202I can be orientated to form a tunnel with openings on either end of the tunnel through which a plurality of glass objects 302 can be conveyed by a conveyor system 206, each of the plurality of temperature zones 202A-202I can be either a heating zone or a cooling zone and each of the plurality of temperature zones 202A-202I and can have an adjustable temperature such that the plurality of temperature zones 202A-202I can be set to implement a temperature profile 306 or 306A-306B as necessary for either annealing or tempering the plurality of glass objects 302. The method continues in block 2004.

In block 2004 the annealing lehr can be configured to temper the plurality of glass objects 302 by making a portion of the conveyor system 206 accessible to a glass object positioning system 204A-204B after preheating of the plurality of glass objects 302. The method continues in block 2006.

In block 2006 the temperature profile 306A-306B is set for tempering the plurality of glass objects 302. The method continues in block 2008.

In block 2008 the plurality of glass object 302 are conveyed through the plurality of temperature zones 202A-202I exposing each of the plurality of glass objects 302 to the temperature profile 306A-306B. The method continues in block 2010.

In block 2010 by way of the glass object positioning system 204A-204B a portion of the plurality of glass objects 302 can be relocated from the conveyor system 206 into a tempering chamber 208. The method continues in block 2012.

In block 2012 the portion of the plurality of glass objects 302 are tempered.

In an exemplary embodiment, tempering can be effectuated by blowing gas or liquid on the portion of the plurality of the glass objects 302 while the portion of the plurality of glass objects 302 are in the tempering chamber 208. Such a gas can be air or other gas, as may be required and or desired in a particular embodiment.

Furthermore, in an exemplary embodiment, the temperature zones 202A-202F can be set to raise the temperature of the plurality of glass objects 302 from an initial starting temperature upon entry into the glass hardening system 210 of less than 700 degrees Celsius to a before tempering stable preheat temperature of approximately 700 degrees Celsius.

In addition, the tempering chamber 208 and the glass object positioning system 204A-204B can be configured to transport and simultaneously temper a plurality of rows of the portion of the plurality of glass objects 302, wherein the number of the plurality of rows can be determined based on conveyor system 206 speed and amount of time required to transport, temper, and return the portion of the plurality of glass objects 302 to the conveyor system 206, without interruption to the plurality of glass objects being transported along the conveyor system. The method continues in block 2014.

In block 2014 the portion of the plurality of glass objects 302 are returned to the conveyor system 206, without interruption to the plurality of glass objects 302 being transported along the conveyor system 206. The method is then exited.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A glass hardening system capable of transition between configurations for annealing and tempering glass objects, the glass hardening system comprising:
a conveyor system;
a glass object positioning system;
a tempering chamber; and
a plurality of temperature zones oriented to form a tunnel with openings on either end of the tunnel through which a plurality of glass objects are conveyed by the conveyor system, each of the plurality of temperature zones being either a heating zone or a cooling zone and each of the plurality of temperature zones having an adjustable temperature, such that the plurality of temperature zones can be set to implement a temperature profile necessary for either annealing or tempering the plurality of glass objects;
wherein the glass hardening system is configured to anneal the plurality of glass objects when the tunnel remains sealed except for openings on either end to allow ingress and egress of the plurality of glass objects and the temperature profile implemented is an annealing temperature profile; and
the glass hardening system is transitioned to temper the plurality of glass objects when the glass hardening system is configured such that a portion of the conveyor system is accessible to the glass object positioning system after preheating of the plurality of glass objects, such that the glass object positioning system can temporarily relocate a portion of the plurality of glass objects from the conveyor system into the tempering chamber, wherein the portion of the plurality of glass objects are tempered and then the portion of the plurality of glass objects is returned to the conveyor system to complete the temperature profile.

2. The glass hardening system in accordance with claim 1, wherein the tempering chamber is located on top of at least one of the plurality of temperature zones above the conveyor system or the tempering chamber is located between the heating zone and the cooling zone in the path of the conveyor system.

3. The glass hardening system in accordance with claim 1, wherein a gas or liquid is blown on the portion of the plurality of glass objects while the portion of the plurality of glass objects are in the tempering chamber, to cool and temper the portion of the plurality of glass objects.

4. The glass hardening system in accordance with claim 1, wherein the tempering chamber and the glass object positioning system are configured to temper simultaneously a plurality of rows of the portion of the plurality of glass objects, wherein number of the plurality of rows is determined based on conveyor system speed and amount of time required to transport, temper, and return the portion of the plurality of glass objects to the conveyor system, without interruption to the plurality of glass objects being transported along the conveyor system.

5. A method of configuring a glass hardening system capable of transition between configurations for annealing and tempering glass objects, the method comprising:
orientating a plurality of temperature zones to form a tunnel with openings on either end of the tunnel through which a plurality of glass objects are conveyed by a conveyor system, each of the plurality of temperature zones being either a heating zone or a cooling zone and each of the plurality of temperature zones having an adjustable temperature, such that the plurality of temperature zones can be set to implement a temperature profile necessary for either annealing or tempering the plurality of glass objects;
setting the temperature profile for either annealing or tempering the plurality of glass objects;
configuring selectively the glass hardening system to anneal the plurality of glass objects by causing the tunnel to remain sealed except for openings on either end to allow ingress and egress of the plurality of glass objects;
configuring selectively the glass hardening system to temper the plurality of glass objects by making a portion of the conveyor system accessible to a glass object positioning system after preheating of the plurality of glass objects, such that the glass object positioning system can temporarily relocate a portion of the plurality of glass objects from the conveyor system into a tempering chamber, wherein the portion of the plurality of glass objects are tempered and then the portion of the plurality of glass objects is returned to the conveyor; and
conveying the plurality of glass objects through the plurality of temperature zones exposing each of the plurality of glass object to the temperature profile, wherein the plurality of glass objects are either annealed or tempered.

6. The method in accordance with claim 5, wherein configuring selectively the glass hardening system to temper the plurality of glass objects further comprising:
raising the temperature of the plurality of glass objects from an initial starting temperature of less than 700 degrees Celsius to a preheat temperature of approximately 700 degrees Celsius.

7. The method in accordance with claim 5, wherein the plurality of glass objects is a plurality of glass vessels.

8. The method in accordance with claim 5, wherein configuring selectively the glass hardening system to temper the plurality of glass objects further comprising:
tempering the portion of the plurality of glass objects by blowing gas or liquid on the portion of the plurality of the glass objects while the portion of the plurality of glass objects are in the tempering chamber.

9. The method in accordance with claim 5, wherein configuring selectively the glass hardening system to temper the plurality of glass objects further comprising:
configuring the tempering chamber and the glass object positioning system to temper simultaneously a plurality of rows of the portion of the plurality of glass objects,

10. The method in accordance with claim 9 wherein number of the plurality of rows is determined based on conveyor system speed and amount of time required to transport, temper, and return the portion of the plurality of glass objects to the conveyor system, without interruption to the plurality of glass objects being transported along the conveyor system.

11. A method of configuring an annealing lehr to temper glass objects, the method comprising:
orientating a plurality of temperature zones to form a tunnel with openings on either end of the tunnel through which a plurality of glass objects are conveyed by a conveyor system, each of the plurality of temperature zones being either a heating zone or a cooling zone and each of the plurality of temperature zones having an adjustable temperature such that the plurality of temperature zones can be set to implement a temperature profile necessary for either annealing or tempering the plurality of glass objects;
configuring the annealing lehr to temper the plurality of glass objects by making a portion of the conveyor system accessible to a glass object positioning system after preheating of the plurality of glass objects;
setting the temperature profile for tempering the plurality of glass objects;
conveying the plurality of glass objects through the plurality of temperature zones exposing each of the plurality of glass object to the temperature profile;
relocating by way of the glass object positioning system a portion of the plurality of glass objects from the conveyor system into a tempering chamber;
tempering the portion of the plurality of glass objects; and
returning the portion of the plurality of glass objects to the conveyor system.

12. The method in accordance with claim 11, wherein tempering further comprising:
blowing gas or liquid on the portion of the plurality of the glass objects while the portion of the plurality of glass objects are in the tempering chamber.

13. The method in accordance with claim 11, further comprising:
raising the temperature of the plurality of glass objects from an initial starting temperature of less than 700 degrees Celsius to a preheat temperature of approximately 700 degrees Celsius.

14. The method in accordance with claim 11, further comprising:
configuring the tempering chamber and the glass object positioning system to transport and simultaneously temper a plurality of rows of the portion of the plurality of glass objects.

15. The method in accordance with claim 14 wherein number of the plurality of rows is determined based on conveyor system speed and amount of time required to transport, temper, and return the portion of the plurality of glass objects to the conveyor system, without interruption to the plurality of glass objects being transported along the conveyor system.
